(19) United States
(12) Patent Application Publication
(10) Pub. No.: US 2025/0236968 A1
(43) Pub. Date: Jul. 24, 2025

(54) SYSTEM AND METHOD FOR CONTROLLING COOLING OF AN ELECTROLYZER UNIT

(71) Applicant: ACWA POWER Company, Riyadh (SA)

(72) Inventor: Venkata Krishna VAKACHARLA, Dubai (AE)

(73) Assignee: ACWA POWER Company, Riyadh (SA)

(21) Appl. No.: 19/035,351

(22) Filed: Jan. 23, 2025

Related U.S. Application Data
(60) Provisional application No. 63/624,165, filed on Jan. 23, 2024.

(51) Int. Cl. C25B 9/67; C01C 1/04; C25B 15/08; F25J 3/04

(52) U.S. Cl. CPC C25B 9/67; C01C 1/0482; C25B 15/081; F25J 3/04612; F25J 3/04775; F25J 3/04848; F25J 2240/12; F25J 2260/02

(57) ABSTRACT

A method and an apparatus for a cooling of an electroyzer unit is described. The apparatus receives a temperature value associated with ambient air in proximal to the electrolyzer unit. The apparatus compares the temperature value with a predefined temperature threshold. The apparatus controls a supply of a liquid air stream from an air separation unit to a first heat exchanger unit based on the comparison. The apparatus control the first heat exchanger unit to mix the liquid air stream with the ambient air. The mixing of the liquid air stream and the ambient air causes transfer of heat therebetween. The apparatus controls a cooling of the electrolyzer unit based on the mixing.

### CROSS-REFERENCE TO RELATED APPLICATION

This application claims priority to U.S. Provisional Patent Application Ser. No. 63/624,165, filed Jan. 23, 2024, and entitled “SYSTEM AND METHOD FOR CRYOGENIC AIR COOLING OF AN ELECTROLYZER UNIT”, the disclosure of which is incorporated herein by reference.

### TECHNOLOGICAL FIELD

The present disclosure relates to cryogenic air cooling, and more particularly relates to systems and methods for sustainable cryogenic air cooling of an electrolyzer unit.

### BACKGROUND

During the production of ammonia, an electrolyzer unit supplies hydrogen to an ammonia production plant. The electrolyzer unit splits water into oxygen and hydrogen using a process called electrolysis. Along with the production of oxygen and hydrogen after the process of electrolysis, heat is also produced. The heat produced due to the electrolysis needs to be removed. Improper release of the heat may lead to increase in the temperature of the electrolyzer unit from an optimal operating temperature range of the electrolyzer unit. Such an increase in the temperature of the electrolyzer unit decreases the production capacity of the electrolyzer unit which leads to improper operational such as, malfunction, fault, and the like.

Traditionally, coolants such as water and air are used to bring down the temperature of the electrolyzer unit within its corresponding optimal range. However, water is expensive to be used in a high quantity, especially in water-scarce areas and draught areas. Also, sometimes air becomes hot and therefore may not be ideal for use for cooling the electrolyzer unit. Hence, there is a requirement for a system that cools down the electrolyzer unit without using water as a coolant media.

### BRIEF SUMMARY

The present disclosure discloses a method, a controller, and an apparatus for cryogenic air cooling of an electrolyzer unit.

In an embodiment, a method for controlling cooling of the electrolyzer unit is provided. The method includes receiving a temperature value associated with ambient air. The ambient air is proximal to an electrolyzer unit. The method further includes comparing the temperature value with a predefined temperature threshold. The method further includes controlling a supply of a liquid air stream from an air separation unit to a first heat exchanger unit based on the comparison. The air separation unit separates one or more components of compressed air to produce the liquid air stream. The method further includes controlling the first heat exchanger unit to mix the liquid air stream with the ambient air. The mixing of the liquid air stream and the ambient air causes transfer of heat therebetween. The method includes controlling a cooling of the electrolyzer unit based on the mixing.

In an embodiment, the method further includes determining the temperature value is one of greater than or equal to the predefined temperature threshold based on the comparison. The method further includes controlling the supply of the liquid air stream from the air separation unit to the first heat exchanger unit based on the determination.

In an embodiment, the method further includes determining the temperature value is lesser than the predefined temperature threshold based on the comparison. The method further includes restricting the supply of the liquid air stream from the air separation unit to the first heat exchanger unit based on the determination.

In an embodiment, the first heat exchanger unit is made of brazed aluminium.

In an embodiment, the method further includes providing a cold box unit within the air separation unit. The cold box unit comprises a first turbine, a second turbine, and a second heat exchanger unit. The method further includes controlling each of the first turbine and the second turbine to separate the one or more components of the compressed air. The method further includes controlling the second heat exchanger unit to regulate a temperature of the cold box unit.

In an embodiment, the method further includes controlling the first turbine to provide refrigeration for a liquid nitrogen stream. The method further includes controlling a supply of the liquid nitrogen stream from the first turbine to a storage unit. The method further includes controlling the storage unit to store the liquid nitrogen stream.

In an embodiment, the method further includes controlling at least one of: the second heat exchanger unit, or the storage unit to supply the liquid nitrogen stream to an ammonia production unit. The method further includes controlling the ammonia production unit to produce liquid ammonia based on the supplied liquid nitrogen stream.

In an embodiment, the method further includes controlling the electrolyzer unit to produce hydrogen. The electrolyzer unit produces the hydrogen and oxygen based on an electrolysis of water. The method further includes controlling the electrolyzer unit to supply the hydrogen to the ammonia production unit. The method further includes controlling the ammonia production unit to produce liquid ammonia based on the supplied hydrogen.

In an embodiment, the method further includes controlling the second turbine to separate the liquid air stream from the compressed air. The liquid air stream excludes the liquid nitrogen stream. The method further includes controlling the supply of the liquid air stream from the second turbine to the first heat exchanger unit.

In an embodiment, the method further includes controlling a compressor unit to generate the compressed air. The compressor unit is controlled to increase a pressure associated with atmospheric air to a predefined pressure value to generate the compressed air. The method further includes controlling a supply of the compressed air from the compressor unit to a purifier unit. The method further includes controlling the purifier unit to generate purified compressed air from the compressed air. The method further includes controlling a supply of the purified compressed air from the purifier unit to the air separation unit. The method further includes controlling the air separation unit to separate the one or more components from the purified compressed air

In an embodiment, the method further includes arranging a temperature monitoring unit in association with the first heat exchanger unit. The method further includes controlling the temperature monitoring unit to monitor a temperature of the ambient air within a predefined distance of the electrolyzer unit. The method further includes receiving the temperature value associated with ambient air based on the monitoring of the temperature of the ambient air.

In another aspect, a controller for controlling a cooling of an electrolyzer unit is provided. The controller includes one or more processors. The one or more processors are configured to receive a temperature value associated with ambient air. The ambient air is proximal to an electrolyzer unit. The one or more processors are further configured to compare the temperature value with a predefined temperature threshold. The one or more processors are further configured to control a supply of a liquid air stream from an air separation unit to a first heat exchanger unit based on the comparison. The air separation unit separates one or more components of compressed air to produce the liquid air stream. The one or more processor are further configured to control the first heat exchanger unit to mix the liquid air stream with the ambient air. The mixing of the liquid air stream and the ambient air causes transfer of heat therebetween. The one or more processors are further configured to control a cooling of the electrolyzer unit based on the mixing.

In an embodiment, the one or more processors are further configured to determine the temperature value is one of greater than or equal to the predefined temperature threshold based on the comparison. The one or more processors are further configured to control the supply of the liquid air stream from the air separation unit to the first heat exchanger unit based on the determination.

In an embodiment, the one or more processors are further configured to provide a cold box unit within the air separation unit. The cold box unit comprises a first turbine, a second turbine, and a second heat exchanger unit. The one or more processors are further configured to control each of the first turbine and the second turbine to separate the one or more components of the compressed air. The one or more processors are further configured to control the second heat exchanger unit to regulate a temperature of the cold box unit.

In an embodiment, the one or more processors are further configured to control the first turbine to separate a liquid nitrogen stream from the compressed air. The one or more processors are further configured to control a supply of the liquid nitrogen stream from the first turbine to a storage unit. The one or more processors are further configured to control the storage unit to store the liquid nitrogen stream.

In an embodiment, the one or more processors are further configured to control at least one of: the second heat exchanger unit, or the storage unit to supply the liquid nitrogen stream to an ammonia production unit. The one or more processors are further configured to control the electrolyzer unit to produce hydrogen. The electrolyzer unit produces the hydrogen and oxygen based on an electrolysis of water. The one or more processors are further configured to control the electrolyzer unit to supply the hydrogen to the ammonia production unit. The one or more processors are further configured to control the ammonia production unit to produce liquid ammonia based on the supplied liquid nitrogen stream and the supplied hydrogen.

In an embodiment, the one or more processors are further configured to control a compressor unit to generate the compressed air. The compressor unit is controlled to increase a pressure associated with atmospheric air to a predefined pressure value to generate the compressed air. The one or more processors are further configured to control a supply of the compressed air from the compressor unit to a purifier unit. The one or more processors are further configured to control the purifier unit to generate purified compressed air from the compressed air. The one or more processors are further configured to control a supply of the purified compressed air from the purifier unit to the air separation unit. The one or more processors are further configured to control the air separation unit to separate the one or more components from the purified compressed air.

In yet another aspect, an apparatus for controlling a cooling of an electrolyzer unit is provided. The apparatus includes an air separation unit configured to separate one or more components of compressed air to produce liquid air stream. The apparatus further includes the electrolyzer unit configured to produce hydrogen and oxygen based on an electrolysis of water. The apparatus further includes a first heat exchanger unit and a controller. The controller is configured to receive a temperature value associated with ambient air. The ambient air is proximal to an electrolyzer unit. The controller is further configured to compare the temperature value with a predefined temperature threshold. The controller is further configured to control a supply of a liquid air stream from an air separation unit to a first heat exchanger unit based on the comparison. The air separation unit separates one or more components of compressed air to produce the liquid air stream. The controller is further configured to control the first heat exchanger unit to mix the liquid air stream with the ambient air. The mixing of the liquid air stream and the ambient air causes transfer of heat therebetween. The controller is further configured to control the cooling of the electrolyzer unit based on the mixing.

In an embodiment, the apparatus further includes a cold box unit provided within the air separation unit. The cold box unit comprises a first turbine, a second turbine, and a second heat exchanger unit. The apparatus further includes an ammonia production unit to produce liquid ammonia.

In an embodiment, the controller is further configured to control the first turbine to separate a liquid nitrogen stream from the compressed air. The controller is further configured to control a supply of the liquid nitrogen stream from the first turbine to a storage unit. The controller is further configured to control the storage unit to store the liquid nitrogen stream. The controller is further configured to control at least one of: the second heat exchanger unit, or the storage unit to supply the liquid nitrogen stream to the ammonia production unit. The controller is further configured to control the electrolyzer unit to produce hydrogen. The electrolyzer unit produces the hydrogen and oxygen based on an electrolysis of water. The controller is further configured to control the electrolyzer unit to supply the hydrogen to the ammonia production unit. The controller is further configured to control the ammonia production unit to produce liquid ammonia based on the supplied liquid nitrogen stream and the supplied hydrogen.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the disclosure in general terms, reference will now be made to the accompanying drawings, which are not necessarily drawn to scale, and wherein:

FIG. 1 illustrates a block diagram of an apparatus for controlling a cooling of an electrolyzer unit, in accordance with an embodiment of the present disclosure;

FIG. 2 illustrates a block diagram of a controller for controlling the cooling of the electrolyzer unit, in accordance with an embodiment of the disclosure;

FIG. 3 illustrates an exemplary block diagram of the apparatus for controlling the cooling of the electrolyzer unit, in accordance with an embodiment of the disclosure;

FIG. 4 illustrates an exemplary block diagram of the apparatus for controlling the cooling of the electrolyzer unit, in accordance with an embodiment of the disclosure;

FIG. 5 illustrates an exemplary block diagram of the apparatus for controlling the cooling of the electrolyzer unit, in accordance with an embodiment of the disclosure;

FIG. 6 is a flowchart of an exemplary method for controlling a flow of the liquid air stream, in accordance with an embodiment of the disclosure; and

FIG. 7 is a flowchart of an exemplary method for controlling the cooling of the electrolyzer unit, in accordance with an embodiment of the disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details. In other instances, systems and methods are shown in block diagram form only in order to avoid obscuring the present disclosure.

Some embodiments of the present disclosure will now be described more fully hereinafter with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. Also, reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

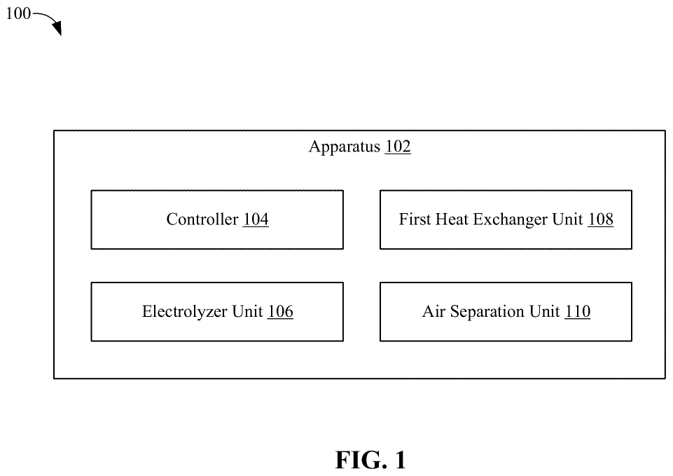

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect. Turning now to FIG. 1-FIG. 7, a brief description concerning the various components of the present disclosure will now be briefly discussed.

FIG. 1 illustrates a block diagram of an apparatus for controlling a cooling of an electrolyzer unit, in accordance with an embodiment of the present disclosure. With reference to FIG. 1, there is shown a block diagram 100. The a block diagram 100 may include an apparatus 102 which may include a controller 104, an electrolyzer unit 106, a first heat exchanger unit 108, an air separation unit 110.

The controller 104 may include suitable logic, circuitry, interfaces, and/or code that may be configured to cool down the electrolyzer unit 106 by bringing a temperature of ambient air proximal to the electrolyzer unit 106 or within a predefined distance from the electrolyzer unit 106 to less than or equal to a predefined temperature threshold. The controller 104 may receive a temperature value associated with the ambient air. The ambient air is proximal to an electrolyzer unit 106. The controller 104 further compares the temperature value with a predefined temperature threshold. The controller 104 further controls a supply of a liquid air stream from the air separation unit 110 to the first heat exchanger unit 108 based on the comparison. The air separation unit 110 separates one or more components of compressed air to produce the liquid air stream. The controller 104 controls the first heat exchanger unit 108 to mix the liquid air stream with the ambient air. The mixing of the liquid air stream and the ambient air causes the transfer of heat therebetween. The controller 104 controls the cooling of the electrolyzer unit based on the mixing. Examples of the controller 104 may include, but are not limited to, a computing device, a mainframe machine, a server, a computer workstation, a smartphone, a cellular phone, a mobile phone, a gaming device, a consumer electronic (CE) device and/or any other device with control system capabilities.

In an embodiment, the electrolyzer unit 106 is utilized for generating of hydrogen and oxygen through electrolysis. The electrolyzer unit 106 operates by passing an electric current through water, which initiates a chemical reaction that splits water molecules into their constituent elements. At a cathode, hydrogen ions are reduced to form hydrogen gas, while at an anode, oxygen is generated through oxidation of water. This process is essential for sustainable energy solutions, as it allows for the production of hydrogen (also referred to as green hydrogen) without carbon emissions.

The electrolyzer unit 106 may correspond to alkaline electrolyzers or proton exchange membrane (PEM) electrolyzers. Alkaline electrolyzers utilize a liquid alkaline solution as the electrolyte, offering durability and cost-effectiveness for large-scale applications. The generated hydrogen can be utilized in various applications, including fuel cells, industrial processes, and as a feedstock for ammonia production.

In an embodiment, the air separation unit 110 is designed to separate atmospheric air into its primary components, such as nitrogen, oxygen, and argon. This process is essential for various applications across multiple industries, including healthcare, manufacturing, food processing, and energy production. The air separation unit 110 operates on the principle of cryogenic distillation, which involves cooling air to extremely low temperatures to liquefy it. The air is compressed and cooled, often using heat exchangers and refrigeration systems, to achieve the necessary low temperatures for liquefaction. Once the air is liquefied, it enters a distillation column where the different components are separated based on their boiling points. Nitrogen, which has a lower boiling point, is drawn off first, followed by oxygen and argon. The separated gases can then be further purified and stored for distribution.

In an embodiment, the first heat exchanger unit 108 provides efficient heat transfer between two fluids typically a cold liquid and a warmer gas or liquid. Constructed primarily from materials like aluminum, the first heat exchanger unit 108 is designed to maximize thermal conductivity and minimize thermal resistance. This design allows for effective heat exchange, where the cold liquid absorbs heat from the warmer air or gas stream. The heat exchanger typically employs a plate or tube configuration, which increases the surface area available for heat transfer. For instance, the first heat exchanger unit 108 receives cold liquified air from the air separation unit 110 and cools the ambient air of the electrolyzer unit 106 by exchanging heat with the cold liquified air. This process lowers the temperature of the ambient air, making it suitable for subsequent separation processes.

In operation, the apparatus 102 or the controller 104 is configured to receive the temperature value associated with the ambient air. The ambient air is proximal to the electrolyzer unit 106. In an example, the one or more sensors are arranged in association with the electrolyzer unit 106 and/or the first heat exchanger unit 108. For instance, the one or more sensors are configured to monitor the temperature value associated with the ambient air. The ambient air corresponds to air the surrounding the environment of the electrolyzer unit 106, such as air surrounding the electrolyzer unit 106 until a predefined distance from the electrolyzer unit 106. The ambient air includes atmospheric air that is present in the vicinity of the electrolyzer unit 106, which may influence the operational efficiency and performance of the electrolyzer unit 106. The ambient air is composed of various gases, including, but not limited to, nitrogen, oxygen, carbon dioxide, and trace amounts of other elements and compounds. The characteristics of the ambient air, such as, but not limited to, temperature, humidity, and pressure, may significantly affect the electrolysis process within the electrolyzer unit 106. For instance, variations in the temperature value may impact the efficiency of hydrogen and oxygen production, while high humidity levels may introduce moisture that could affect the components of the electrolyzer unit 106.

The temperature value is crucial for optimizing the performance of the electrolyzer unit 106, which is responsible for producing hydrogen and oxygen through the process of electrolysis. To effectively monitor the ambient conditions, the one or more sensors are strategically positioned near the electrolyzer unit 106. The one or more sensors are specifically configured to continuously monitor the temperature of the ambient air, providing real-time data that may be used to make informed decisions regarding the operation of the electrolyzer unit 106.

The electrolyzer unit 106 is utilized for the production of green hydrogen and green oxygen. During the electrolysis process, the water is split into the green hydrogen and green oxygen using electrical energy. For example, the electrical energy and the water are sourced from renewable resources. Subsequently, the output hydrogen is considered to be green hydrogen, and the output oxygen is considered to be green oxygen. To this end, the efficiency of the electrolysis process may be adversely affected by temperature fluctuations. As the temperature of the electrolyzer unit 106 increases, it may lead to a decrease in the efficiency of the electrolysis process. Higher temperatures may cause increased resistance in the electrolytic cells, which in turn requires more energy to achieve the same level of hydrogen production. This inefficiency not only impacts on the overall output of green hydrogen but can also lead to higher operational costs.

Further, the apparatus 102 or the controller 104 is configured to compare the temperature value associated with the ambient air with a predefined temperature threshold. By way of example, and not by limitation, the apparatus 102 or the controller 104 compares the temperature value associated with the ambient air surrounding the electrolyzer unit 106 with the predefined temperature threshold. The predefined temperature threshold is established based on optimal operating conditions for the electrolyzer unit 106, ensuring that the electrolysis process remains efficient and effective. By continuously assessing the ambient temperature against the predefined temperature threshold, the controller 104 may make real-time decisions that directly impact the performance of the electrolyzer unit 106.

By way of example, and not by limitation, when the temperature of the ambient air is within the acceptable range, such as less than the predefined temperature threshold, the electrolyzer unit 106 may operate at peak efficiency, facilitating the effective production of green hydrogen and green oxygen. However, if the ambient temperature exceeds the predefined threshold, the controller 104 can initiate corrective actions to mitigate any potential negative effects on the electrolysis process. For example, if the temperature rises too high, the controller may activate cooling systems, such as, but not limited to, coolant, fans, or heat exchangers, to lower the temperature of the air surrounding the electrolyzer unit 106, thereby reducing temperature of the electrolyzer unit 106.

Further, the apparatus 102 or the controller 104 is configured to control a supply of a liquid air stream from the air separation unit 110 to the first heat exchanger unit 108 based on the comparison. The air separation unit 110 separates one or more components of compressed air. By way of example, and not by limitation, the air separation unit 110 is operable to separate various elements of compressed air through cryogenic processes. By cooling the compressed air to extremely low temperatures, the air separation unit 110 may liquefy certain components, such as, but not limited to, the nitrogen and the green oxygen, allowing for their effective separation. This process is essential for producing the liquid air stream, which can be utilized in various applications, including, but not limited to, production of green nitrogen, cooling and thermal management. For example, as the nitrogen is derived from renewable resources, i.e., air, the nitrogen may also be considered green nitrogen.

Further, the apparatus 102 includes the first heat exchanger unit 108 which enables the transfer of heat between two or more fluids without mixing them. In this context, the first heat exchanger unit 108, which may be a brazed aluminum heat exchanger, is specifically designed to absorb excess heat from ambient air of the electrolyzer unit 106, thereby maintaining optimal operating conditions for the electrolysis process.

In an embodiment, the controller 104 is configured to control the supply of the liquid air stream from the air separation unit 110 to the first heat exchanger unit 108 based on real-time temperature comparisons. The controller 104 continuously monitors the temperature of the ambient air surrounding the electrolyzer unit 106 and compares it to the predefined temperature threshold. When the temperature value of the ambient air exceeds the predefined temperature threshold, indicating a potential risk of overheating within the electrolyzer unit 106, the controller 104 causes the flow of the liquid air stream from the air separation unit 110 to the first heat exchanger unit 108.

By supplying the liquid air stream to the first heat exchanger unit 108, the controller 104 enables the first heat exchanger unit 108 to effectively absorb excess heat from the ambient air generated during the electrolysis process. The liquid air stream circulates through the first heat exchanger unit 108, where it absorbs heat from the ambient air of the electrolyzer unit 106, thereby cooling down the electrolyzer unit 106 and preventing any efficiency losses associated with high temperatures. This dynamic control of the liquid air stream supply not only optimizes the performance of the electrolyzer unit 106 but also enhances the overall reliability and longevity of the apparatus 102. In essence, the integration of the air separation unit 110 and the first heat exchanger unit 108, along with the controller's ability to respond to temperature changes, creates a robust thermal management system that supports efficient hydrogen production while safeguarding the operational integrity of the electrolyzer unit 106.

Further, the apparatus 102 or the controller 104 is configured to control the first heat exchanger unit 108 to mix the liquid air stream with the ambient air. The mixing of the liquid air stream and the ambient air causes the transfer of heat therebetween. By way of example, and not by limitation, the controller 104, is designed to optimize thermal management by controlling the first heat exchanger unit 108 to mix the liquid air stream with the ambient air. This is essential for effective heat transfer to maintain the operational efficiency of the electrolyzer unit 106. When the controller 104 determines that the ambient temperature is greater than or equal to the predefined temperature threshold, the controller 104 initiates the mixing of the liquid air stream with the surrounding ambient air within the first heat exchanger unit 108. In an example, the mixing of the liquid air stream and the ambient air does not correspond to physical interaction or mixing of the two gases. For example, the mixing of the liquid air stream and the ambient air corresponds to bringing the two gases in indirect contact so that the heat transfer can take place between them. In an example, the liquid air stream may be passed through a network of pipes while the ambient air may be present in area surrounding the pipe. This may ensure that the liquid air stream is not chemically mixed with the ambient air.

In an embodiment, the apparatus 102 or the controller 104 is configured to control a cooling of the electrolyzer unit 106 based on the mixing. In an example, the mixing of the liquid air stream and the ambient air enables a heat exchange process where thermal energy is transferred between the liquid air stream and the ambient air. For instance, the liquid air stream, being at a significantly lower temperature, absorbs heat from the warmer ambient air. As the ambient air and the liquid air stream are mixed, the heat from the ambient air is transferred to the liquid air stream, causing the liquid air stream to warm up while simultaneously cooling the ambient air. This process effectively lowers the temperature of the ambient air, which prevents overheating in the electrolyzer unit 106.

The first heat exchanger unit 108 is designed to maximize this heat transfer efficiency. By utilizing a brazed aluminum construction, the first heat exchanger unit 108 provides a large surface area for contact between the liquid air stream and the ambient air, enhancing the rate of heat exchange. The controller 104 continuously monitors the temperature of both the liquid air stream and the ambient air, adjusting the flow rates and mixing ratios as necessary to optimize the heat transfer or cooling effect. This control ensures that the electrolyzer unit 106 operates within its ideal temperature range. By effectively managing the temperature, the apparatus 102 can reduce the energy required for the electrolysis process, leading to lower operational costs and improved sustainability. Additionally, this thermal management strategy can enhance the longevity of the components of the electrolyzer unit 106 by preventing thermal stress and wear associated with high temperatures.

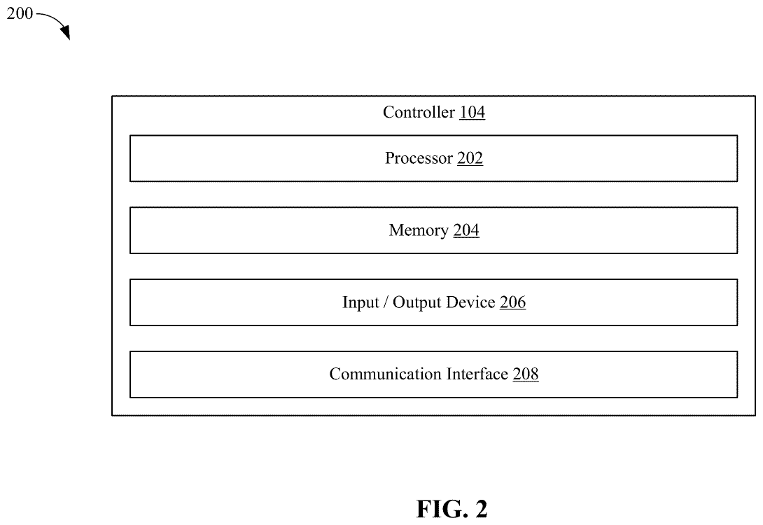

FIG. 2 illustrates a block diagram 200 of the controller 104 for controlling the cooling of the electrolyzer unit 106, in accordance with an embodiment of the disclosure. FIG. 2 is explained in conjunction with FIG. 1. In FIG. 2, there is shown the block diagram 200 of the controller 104. The controller 104 may include one or more processors 202 (referred to as a processor 202, hereinafter), at least one non-transitory memory 204 (referred to as a memory 204, hereinafter), an input/output device (I/O) device 206, and a communication interface 208. The processor 202 may be connected to the memory 204, the I/O device 206, and the communication interface 208 through one or more wired or wireless connections. Although in FIG. 2, it is shown that the controller 104 includes the processor 202, the memory 204, the I/O device 206, and the communication interface 208 however, the disclosure may not be so limiting and the controller 104 may include fewer or more components to perform the same or other functions of the controller 104.

The processor 202 of the controller 104 may be configured to control cryogenic air cooling of the electrolyzer unit 106. The processor 202 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application-specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally, or alternatively, the processor 202 may include one or more processors configured in tandem via the bus to enable independent execution of instructions, pipelining, and/or multithreading. Additionally, or alternatively, the processor 202 may include one or more processors capable of processing large volumes of workloads and operations to provide support for big data analysis. In an example embodiment, the processor 202 may be in communication with the memory 204 via a bus for passing information among components of the controller 104.

In an example, when the processor 202 may be embodied as an executor of software instructions, the instructions may specifically configure the processor 202 to perform the algorithms and/or operations described herein when the instructions are executed. However, in some cases, the processor 202 may be a processor-specific device (for example, a mobile terminal or a fixed computing device) configured to employ an embodiment of the present disclosure by further configuration of the processor 202 by instructions for performing the algorithms and/or operations described herein. The processor 202 may include, among other things, a clock, an arithmetic logic unit (ALU), and logic gates configured to support the operation of the processor 202.

The memory 204 may be non-transitory and may include, for example, one or more volatile and/or non-volatile memories. In other words, for example, the memory 204 may be an electronic storage device (for example, a computer readable storage medium) comprising gates configured to store data (for example, bits) that may be retrievable by a machine (for example, a computing device like the processor 202). The memory 204 may be configured to store information, data, content, applications, instructions, or the like, for enabling the controller 104 to carry out various functions in accordance with an example embodiment of the present disclosure. As exemplarily illustrated in FIG. 2, the memory 204 may be configured to store instructions for execution by the processor 202. As such, whether configured by hardware or software methods, or by a combination thereof, the processor 202 may represent an entity (for example, physically embodied in circuitry) capable of performing operations according to an embodiment of the present disclosure while configured accordingly. Thus, for example, when the processor 202 is embodied as an Application Specific Integrated Circuit (ASIC), Field Programmable Gate Array (FPGA), or the like, the processor 202 may be specifically configured hardware for conducting the operations described herein.

In some example embodiments, the I/O device 206 may communicate with the controller 104 and display the input and/or output of the controller 104. As such, the I/O device 206 may include a display and, in some embodiments, may also include a keyboard, a mouse, a touch screen, touch areas, soft keys, or other input/output mechanisms. In one embodiment, the controller 104 may include a user interface circuitry configured to control at least some functions of one or more I/O interface elements such as a display and, in some embodiments, a plurality of speakers, a ringer, one or more microphones and/or the like. The processor 202 and/or I/O device 206 circuitry comprising the processor 202 may be configured to control one or more functions of one or more I/O device 206 elements through computer program instructions (for example, software and/or firmware) stored on a memory 204 accessible to the processor 202.

The communication interface 208 may comprise the input interface and output interface for supporting communications to and from the controller 104 or any other component with which the controller 104 may communicate. The communication interface 208 may be any means such as a device or circuitry embodied in either hardware or a combination of hardware and software that is configured to receive and/or transmit data to/from a communications device in communication with the controller 104. In this regard, the communication interface 208 may include, for example, an antenna (or multiple antennae) and supporting hardware and/or software for enabling communications with a wireless communication network. Additionally, or alternatively, the communication interface 208 may include the circuitry for interacting with the antenna(s) to cause transmission of signals via the antenna(s) or to handle receipt of signals received via the antenna(s). In some environments, the communication interface 208 may alternatively or additionally support wired communication. As such, for example, the communication interface 208 may include a communication modem and/or other hardware and/or software for supporting communication via cable, digital subscriber line (DSL), universal serial bus (USB), or other mechanisms.

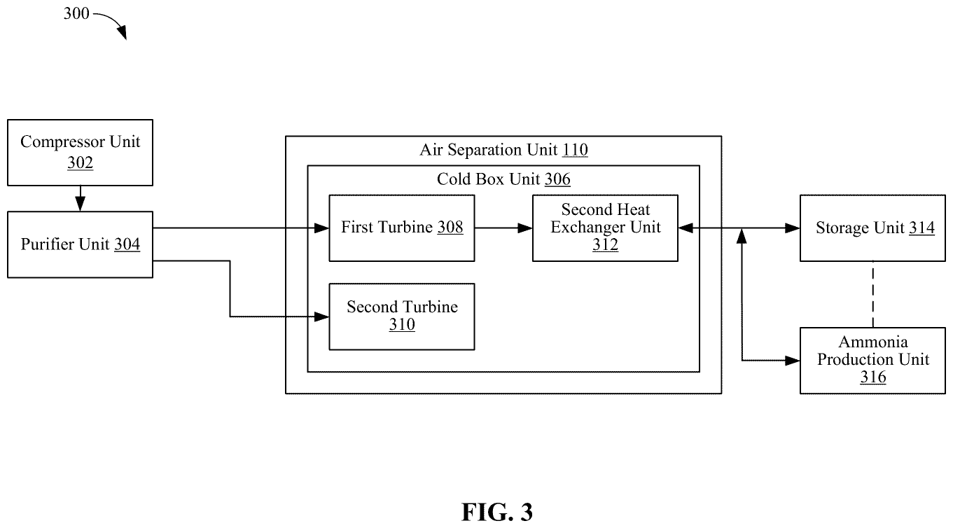

FIG. 3 illustrates an exemplary block diagram 300 of the apparatus for controlling the cooling of the electrolyzer unit 106, in accordance with an embodiment of the disclosure. FIG. 3 is explained in conjunction with FIG. 1 and FIG. 2.

In an embodiment, the apparatus 102 comprises a compressor unit 302. The controller 104 is configured to control a supply of compressed air from the compressor unit 302 to a purifier unit 304. The compressor unit 302 is controlled to increase a pressure associated with the atmospheric air to a predefined pressure value. By way of example, and not by limitation, the compressor unit 302 compresses the atmospheric air by increasing the pressure of the atmospheric air. The compressor unit 302 may elevate the pressure of the atmospheric air to enhance the efficiency of downstream processes that may rely on the compressed air. In an exemplary embodiment, the compressor unit 302 may intake the air from the surroundings of the compressor unit 302. Further, the compressor unit 302 may compress the air by increasing the pressure of the air from a first pressure value to the predefined pressure value. The predefined pressure value may be, for example, 5 bar, 7 bar, 12 bar, 20 bar, 40 bar, or the like. During the compression of the ambient air in the compressor unit 302, the volume of the atmospheric air may decrease, and the pressure of the atmospheric air may increase. Further, the compressed air may be directed to the purifier unit 304 from the compressor unit 302.

In an embodiment, the atmospheric air, in the compressor unit 302, may initially go through a filtration process to remove impurities such as dust and particulate matter, helping to protect the compressor unit 302 components and thereby ensuring the quality of compressed air. The filtered atmospheric air may be directed into a compression chamber within the compressor unit 302 for compression.

In an embodiment, the filtration process may include removing moisture from the atmospheric air. The moisture removal is important because excess humidity in the compressed air may lead to various issues, such as, but not limited to, corrosion of internal components of the apparatus 102, reduced efficiency, and compromised quality of the compressed air. By eliminating moisture before compression, the apparatus 102 ensures that the compressed air is dry and suitable for various applications. For instance, the moisture removal process may correspond to a refrigerant dryer or a desiccant dryer. A refrigerant dryer cools the atmospheric air, causing moisture to condense and be removed, while a desiccant dryer uses materials that absorb moisture from the atmospheric air. By implementing such moisture removal techniques, the compressor unit 302 ensures that the air entering the compression chamber is dry.

Further, the apparatus 102 includes the purifier unit 304. The controller 104 is configured to control the purifier unit 304 to generate purified compressed air from the compressed air by removing impurities from the compressed air. The compressed air is supplied to the purifier unit 304. The purifier unit 304 may filter the compressed air from the compressor unit 302 to remove large particles, dust, and debris from the compressed air. The purifier unit 304 may further incorporate a mechanism to remove moisture from the compressed air. For example, purifier unit 304 may employ desiccant beds or dryers to eliminate any remaining water vapor from the compressed air, thereby ensuring that the compressed air is dry.

In an embodiment, the apparatus may include the air separation unit 110. The air separation unit 110 includes a cold box unit 306. The controller 104 is configured to control a supply of the purified compressed air from the purifier unit 304 to the air separation unit 110. In an embodiment, the controller 104 is configured to control the cold box unit 306 associated with the air separation unit 110 to convert the purified compressed air into the liquid air stream and liquid nitrogen stream. In particular, the liquid air stream is exclusive of, i.e., does not include, the liquid nitrogen stream.

The air separation unit 110 is configured to generate a liquid nitrogen stream (also referred to as green nitrogen). In an example, the controller 104 is configured to control a first turbine 308 of the air separation unit 110 to separate the liquid nitrogen stream from the purified compressed air. In other words, the first turbine 308 is configured to provide refrigeration for the liquid nitrogen stream of the purified compressed air, thereby separating the the liquid nitrogen stream or the green nitrogen therein.

In an embodiment, the air separation unit 110, specifically, the cold box unit may include multiple turbines. For example, different turbines may provide refrigeration to different gasses to carry out separation of different gases from the purified compressed air. The different turbines may be set to different temperature to provide refrigeration at different preset temperature. These preset temperatures may be dependent on condensation points or freezing points of the different gases. For example, the one or more gases may correspond to primary components of the purified compressed air including, but not limited to, green oxygen, green nitrogen, green carbon, green argon, or a combination thereof. Examples of different types of air separation unit 110 may include, but are not limited to, a cryogenic air separation unit, a pressure swing adsorption (PSA) unit, a membrane air separation unit, a vacuum pressure swing adsorption (VPSA) unit, and a hybrid air separation unit.

Pursuant to the present example, the first turbine 308 may provide refrigeration to the liquid nitrogen stream. Thereafter, the controller 104 is configured to control a supply of the liquid nitrogen stream from the first turbine 308 to a storage unit 314. The controller 104 is further configured to control the storage unit 314 to store the liquid nitrogen stream. The storage unit may be, for example, insulated containers for storing the liquid nitrogen stream in the same fluid state.

Moreover, the cold box unit 306 includes a second turbine 310. The second turbine 310 is configured to provide refrigeration to, for example, gases other than nitrogen of the purified compressed air supplied thereto. In an example, the second turbine 310 is configured to provide refrigeration to argon, oxygen, and/or carbon. To this end, the second turbine is configured to produce a liquid air stream. The liquid air stream may include oxygen, carbon, argon, of a combination thereof.

The cold box unit 306 comprises a second heat exchanger unit 312. The cold box unit 306 may receive purified air from the purifier unit 304. The purified air received from the purifier unit 304 may be free from water molecules that may condense to form liquid, solid or semi-solid in the cold box unit 306. The cold box unit 306 may be used for cryogenic applications. The cold box unit 306 may be a container or a vessel that may be designed for the cooling and liquefaction of gases. The cold box unit 306 may be employed in the cryogenic processes where gases such as green nitrogen, green oxygen, and green argon separated in the air separation unit 110 may be liquefied for industrial use. The walls of the cold box unit 306 may be well insulated to minimize heat exchange with the external environment. The insulation may be crucial to maintain the extremely low temperatures required for the liquefaction of gases inside the cold box unit 306.

Further, the controller 104 is configured to control a supply of the liquid nitrogen stream or the green nitrogen from the air separation unit 110 to an ammonia production unit 316. By way of example, and not by limitation, the air separation unit 110 may receive the compressed purified air. The compressed purified air may be fed into a distillation column of the air separation unit 110. The distillation column may be a large vertical column that may be equipped with trays and packing. This column may operate at extremely low temperatures, allowing the different primary components of air to condense based on their condensation points. As an example, in the distillation column, nitrogen with a boiling point of −196 degrees Celsius may condense at a higher level, while the oxygen with a boiling point of −183 degrees Celsius may condense at a lower level, and argon, with a boiling point lower than oxygen, may be separated. The distillation column may be operated using the first turbine 308 and the second turbine 310.

The second heat exchanger unit 312 that may manage and regulate temperature of the one or more gases generated therein as well as regulate heat generated by the operation of the cold box unit 308. The second heat exchanger unit 312 may facilitate the transfer of heat from hot ambient air to colder air to maintain the required temperatures inside the air separation unit. The ambient air may get hot due to operation of the first turbine 308, the second turbine 310, other components of the cold box unit 306, or other components of the air separation unit 110, helping to regulate the temperature of the liquid nitrogen stream and the liquid air stream as it may progress to the cryogenic process. The second heat exchanger unit 312 may operate on any heat exchange principle and may ensure optimal cooling and liquefaction of nitrogen and other gases within the cold box unit 306. Further, the liquid nitrogen stream is stored in the storage unit 314.

The apparatus 102 may include the storage unit 314. The storage unit 314 may receive and store the liquid nitrogen stream produced in the cold box unit 306 during the cryogenic process. The storage unit 314 may be equipped with insulated tanks that may maintain extremely low temperatures that may be required for storing the liquid nitrogen stream. The storage unit 314 may correspond to at least one of a stationary bulk storage tank, a portable cryogenic dewars, a specialized container, and the like. The liquid nitrogen stream stored in the storage unit 314 may be transferred to the ammonia production unit 316 for the production of liquid ammonia (NH₃). As the liquid ammonia is generated from renewable resources, the liquid ammonia is also considered to be green ammonia.

The apparatus 102 may include the ammonia production unit 316. The ammonia production unit may be a facility for the synthesis or the production of the green ammonia (NH₃). The ammonia production unit 316 may utilize a Haber-Bosch process to synthesize the green ammonia by reacting cold green liquid nitrogen stream from the storage unit 314 and the green hydrogen from the electrolyzer unit 106 at high pressure and temperature. Specifically, the ammonia production unit 316 may receive the green hydrogen from the electrolyzer unit 106. The ammonia production unit 316 may receive the green liquid nitrogen stream from the storage unit 314 associated with the cold box unit 306, or the second heat exchanger unit 312 or the first turbine 308 of the cold box unit 306 itself, for the production of the green ammonia (NH₃). In an example, the controller 104 is configured to control the ammonia production unit 316 to produce liquid green ammonia based on the supplied liquid nitrogen stream.

Various methods for the production of the liquid ammonia in the ammonia production unit 316 may include, but are not limited to, a steam methane reforming (SMR) method, a gasification of coal method, an electrolysis method, or a partial oxidation method.

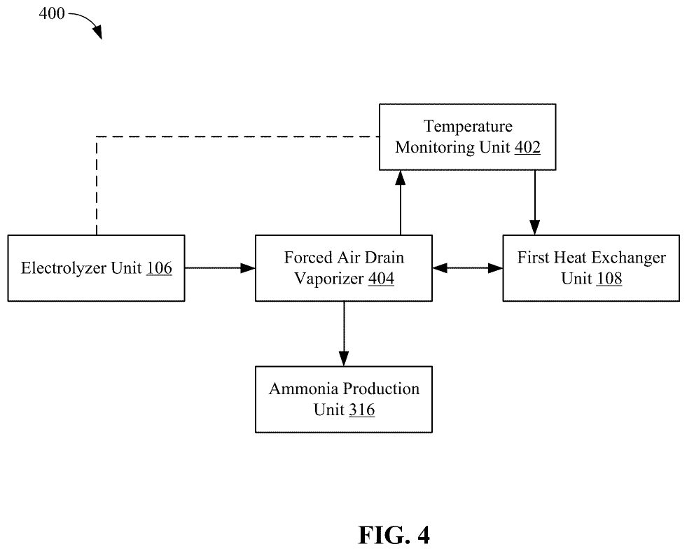

FIG. 4 illustrates an exemplary block diagram 400 of the apparatus 102 for controlling the cooling of the electrolyzer unit 106, in accordance with an embodiment of the disclosure. FIG. 4 is explained in conjunction with FIG. 1, FIG. 2, and FIG. 3.

According to an example, the apparatus 102 includes the electrolyzer unit 106, a temperature monitoring unit 402, a forced air drain vaporizer 404, the first heat exchanger unit 108 and the ammonia production unit 316.

In an embodiment, the electrolyzer unit 106 may be configured to utilize the process of electrolysis to split water into green hydrogen and green oxygen by passing an electric current through the water. The chemical reaction during the process of electrolysis may involve the decomposition of water molecules into the green hydrogen and the green oxygen gas. Specifically, at the cathode, water molecules are reduced to produce green hydrogen gas, while at the anode, oxidation occurs, resulting in the generation of green oxygen gas. The electrolyzer unit 106 may transfer the generated green hydrogen to the ammonia production unit 316 for the production of the green ammonia. Different types of electrolyzer unit 106 may include, but are not limited to, an alkaline electrolyzer, and a proton exchange membrane electrolyzer (PEM).

The electrolyzer unit 106 operates by utilizing electrodes submerged in an electrolyte solution. When an electric current is applied, the electrolyzer unit 106 initiates the electrochemical reactions necessary for the decomposition of water. The efficiency of this process is influenced by various factors, including a type of the electrolyzer used, a composition of the electrolyte, and operating conditions such as temperature and pressure of the electrolyzer unit 106.

Different types of electrolyzers can be employed within the electrolyzer unit 106. For instance, alkaline electrolyzers utilize a liquid alkaline solution as the electrolyte, which allows for efficient hydrogen production at relatively low costs. In an example, proton exchange membrane (PEM) electrolyzers utilize a solid polymer membrane as the electrolyte. This type of electrolyzer is characterized by its ability to operate at higher pressures and temperatures, resulting in faster response times and higher purity hydrogen production. The PEM electrolyzers are particularly advantageous in applications where rapid fluctuations in power supply are expected, such as in renewable energy systems that rely on solar or wind power.

The first heat exchanger unit 108 may be a type of heat exchanger unit that may utilize aluminum as a primary material and may employ brazing as the joining method. Subsequently, the first heat exchanger unit 108 may be made of brazed aluminum. For instance, the first heat exchanger unit 108 is configured to enable heat transfer process.

In an embodiment, the brazing process used in the construction of the first heat exchanger unit 108 further enhances the efficiency of the first heat exchanger unit 108. Brazing involves joining aluminum plates using a filler metal, creating strong, durable connections that ensure high thermal contact between the plates. This close contact minimizes thermal resistance, allowing for more effective heat transfer. The design of the first heat exchanger unit 108, often in a plate configuration, maximizes the surface area available for heat exchange, further improving the efficiency of the process. Different types of heat exchangers can be classified under the umbrella of the first heat exchanger unit 108, including brazed plate heat exchangers (BPHE), brazed aluminum radiators, brazed aluminum oil coolers, and brazed aluminum condensers. Each of these designs utilizes the same fundamental principles of heat transfer but may be optimized for specific applications.

In an embodiment, the temperature monitoring unit 402 is arranged in association with the first heat exchanger unit 108 and/or the electrolyzer unit 106. In an example, the temperature monitoring unit 402 includes one or more temperature sensors configured to monitor a temperature value of the ambient air in the vicinity of the electrolyzer unit 106. Further, the controller 104 is configured to control the temperature monitoring unit 402 to monitor the temperature of the ambient air within a predefined distance of the electrolyzer unit 106.

For instance, the temperature monitoring unit 402 may be configured to measure or sense the temperature of the ambient air within a predefined distance of the electrolyzer unit 106. Further, the sensed temperature is transferred to the controller 104 to enable the controller 104 to monitor the temperature of the ambient air. Monitoring the temperature allows for effective monitoring of environmental conditions that may impact the performance of the electrolyzer unit 106. Further, the controller 104 is configured to receive the temperature value associated with the ambient air based on the monitoring of the temperature of the ambient air. For instance, the temperature monitoring unit 402 continuously senses the temperature of the ambient air within a predefined distance from the electrolyzer unit 106 and transmits it to the controller 104, ensuring that the controller 104 has access to real-time data regarding environmental conditions. Based on sensor data received by the controller 104 from the temperature monitoring unit 402, the controller 104 may assess if a temperature value of the ambient air is within an optimal range for efficient electrolysis or not.

By way of example, and not by limitation, the one or more temperature sensors utilized within the temperature monitoring unit 402 may include thermocouples, resistance temperature detectors (RTDs), infrared thermometers, thermal imaging cameras, and fiber optic temperature sensors.

Further, the apparatus 102 or the controller 104 is configured to control the electrolyzer unit 106 to supply the hydrogen to the ammonia production unit 316. In an example, once the green hydrogen is generated, the green hydrogen can be transferred to the ammonia production unit 316 for the synthesis of green ammonia. Further, the controller 104 is configured to control the ammonia production unit 316 to produce the liquid ammonia based on the supplied hydrogen. This process typically involves combining the hydrogen with the supplied nitrogen stream, which can be sourced from the cold box unit 306 and/or the storage unit 314, to produce the green ammonia through the Haber-Bosch process. The production of the green ammonia is significant as it serves as a carbon-free energy carrier and a key ingredient in fertilizers, contributing to sustainable agricultural practices. Details associated with the ammonia production unit 316 are described in conjunction with, for example, FIG. 3.

Further, the force air drain vaporizer 404 may be configured to convert liquid gas into vapors. The forced air drain vaporizer 404 may employ forced air by using a fan or a blower to enhance the vaporization process. The forced air drain vaporizer 404 may utilize the ambient air as the heat source and may eliminate the need for external heating elements. Different types of forced air drain vaporizer 404 may include, but are not limited to, an ambient vaporizer, a high-pressure vaporizer, and a submerged combustion vaporizer.

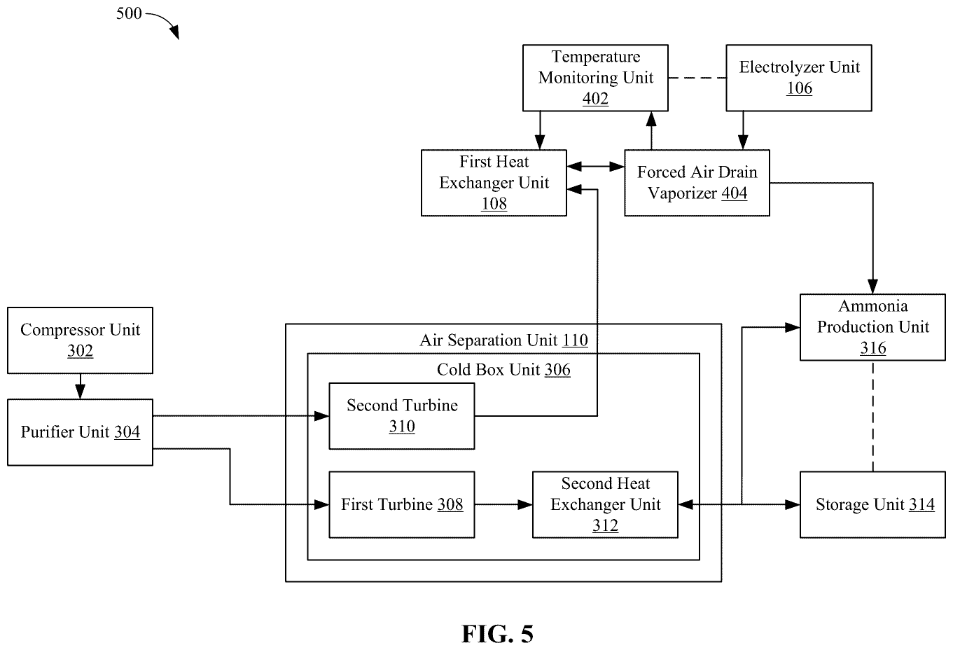

FIG. 5 illustrates an exemplary block diagram 500 of the apparatus 102 for controlling the cooling of the electrolyzer unit 106, in accordance with an embodiment of the disclosure. FIG. 5 is explained in conjunction with FIG. 1, FIG. 2, FIG. 3, and FIG. 4.

In an embodiment, the controller 104 is configured to control the compressor unit 302 to generate the compressed air. The compressor unit 302 is controlled to increase the pressure associated with the atmospheric air to the predefined pressure value to generate the compressed air.

Further, the controller 104 is configured to control the supply of the compressed air from the compressor unit 302 to the purifier unit. Further the controller 104 is configured to control the purifier unit 304 to generate the purified compressed air from the compressed air. The purifier unit 304 may purify the compressed air to remove dust, particulate matter, and water molecules and dust particles from the compressed air. The removal of water molecules from the compressed air may ensure that ice formation in the cold box unit 306 may be avoided while cooling down the purified compressed air.

Further, the controller 104 is configured to control the supply of the purified compressed air from the purifier unit 304 to the air separation unit 110. For instance, the controller 104 ensures that the air separation unit 110 receives a consistent and adequate flow of the purified compressed air, which is essential for the efficient separation of one or more components or one or more gases into a liquid air stream.

Further, the controller 104 is configured to control the air separation unit 110 to separate the one or more components from the purified compressed air. In an embodiment, the air separation unit 110 includes the cold box unit 306. The controller 104 is configured to control the cold box unit 306 to produce the liquid nitrogen stream from the purified compressed air. The produced liquid nitrogen stream may be stored in the storage unit 314. For example, the liquid nitrogen stream that may be separated in the air separation unit 110 may be cooled down to its boiling point which may be, for example, (−196 degrees Celsius). Upon reaching a condensation point of the nitrogen, the liquid nitrogen stream may be refrigerated in the first turbine 308. The liquid nitrogen stream may be used for ammonia synthesis process in the ammonia production unit 316.

For example, the liquid nitrogen stream may be safely held for future use in the storage unit 314. The controller 104 monitors various parameters, such as the flow rate, pressure, and temperature of the liquid nitrogen stream.

Further, the controller 104 is configured to control the first turbine 308 to provide refrigeration for the liquid nitrogen stream. In an example, the first turbine 308 of the cold box unit 306 is controlled to provide the refrigeration of the liquid nitrogen stream. For instance, this control is crucial for maintaining the low temperatures required for the effective liquefaction and storage of nitrogen. When the first turbine is activated, it expands the cooled air or nitrogen, resulting in a significant drop in temperature due to the Joule-Thomson effect. This cooling process is essential for achieving the desired refrigeration levels necessary for the liquid nitrogen stream.

By regulating the operation of the first turbine 308, the controller 104 may adjust the flow rate and pressure of nitrogen, ensuring that the refrigeration process is optimized based on real-time conditions. For instance, if the demand for liquid nitrogen increases or if ambient temperatures rise, the controller 104 may increase the speed of the first turbine 308 to enhance cooling efficiency. Conversely, if the temperature is sufficiently low, the controller 104 may reduce the turbine's operation to conserve energy. In certain cases, the controller 104 regulates the flow of the liquid nitrogen stream to the storage unit 314 based on real-time demand and operational conditions. For instance, if the storage unit 314 reaches its capacity, the controller 104 may reduce or halt the first turbine 308, thereby halting the production of the liquid nitrogen stream and halting a supply of the liquid nitrogen to the storage unit 314. Conversely, if there is an increased demand for liquid nitrogen stream in downstream applications, the controller 104 may control the first turbine 308 such that production of an amount of nitrogen per unit time is increased to meet that demand promptly.

In another embodiment, the controller 104 is configured to control the air separation unit 110 to separate one or more components (or one or more gases) from the air. The one or more gases may include green oxygen, green nitrogen, and green argon. For example, upon receiving the purified air from the purifier unit 304 using the first turbine 308, the air separation unit 110 may separate the liquid nitrogen stream from the purified compressed air. Further, using the second turbine 308, the air separation unit 110 may separate the liquid air stream air from the purified compressed air.

The controller 104 continuously monitors key parameters within the storage unit, such as temperature, pressure, and liquid level. By doing so, it can make real-time adjustments to maintain the ideal storage conditions. For instance, if the temperature of the liquid nitrogen begins to rise, the controller 104 can activate cooling mechanisms or adjust the flow rate from the first turbine to ensure that the nitrogen remains in its liquid state.

Additionally, the controller 104 implements safety protocols to prevent overfilling or pressure buildup within the storage unit. If the liquid nitrogen level approaches capacity, the controller 104 can restrict the inflow from the turbine, thereby preventing potential hazards.

In an embodiment, the controller 104 may be configured to control the supply of the green nitrogen from the air separation unit 110 to the ammonia production unit 316 for the production of the green ammonia. For example, the green nitrogen that is separated by the air separation unit 110 or stored in the storage unit 314 may be supplied to the ammonia production unit 316. The liquid nitrogen stream may be used by the ammonia production unit 316 for the ammonia synthesis process for the production of the green ammonia.

In another embodiment, the controller 104 may control the electrolyzer unit 106 for the generation of green hydrogen for the production of green ammonia in the ammonia production unit 316. The controller 104 may further control a temperature monitoring unit 402 that may be associated with the electrolyzer unit 106 and the first heat exchanger unit 108. During the generation of the green hydrogen, the temperature of the electrolyzer unit 106 may increase. This increase in the temperature may result in a substantial decrease in the production of green hydrogen used for the production of green ammonia. Therefore, to cool down the temperature of the electrolyzer unit 106, the controller 104 may control the temperature monitoring unit 402 to monitor the temperature of the air within a predefined distance of the electrolyzer unit 106.

In one embodiment, the controller 104 may be configured to control the electrolyzer unit 106 to generate the green hydrogen by splitting the water into the green hydrogen and green oxygen at an electrolyzing temperature. Further, the controller 104 may control the supply of the green hydrogen from the electrolyzer unit 106 to the ammonia production unit 316 for the production of the green ammonia. The green hydrogen is used for the ammonia synthesis process along with the liquid nitrogen stream for the production of the green ammonia.

Further, the controller 104 may compare the temperature value of the ambient air with the predefined temperature threshold. The predefined temperature threshold for the ambient air within a predefined distance of the electrolyzer unit 106 may correspond to the maximum value of the optimal temperature around the electrolyzer unit 106 until the production of green hydrogen may be optimal. For example, the predefined temperature threshold may be set to 36 degrees Celsius.

In yet another embodiment, the controller 104 may control the supply of the liquid air stream into the first heat exchanger unit 108 from the second turbine 310 of the cold box unit 306 based on the determination that the temperature value of the ambient air around the electrolyzer unit 106 is greater than the predefined temperature threshold. For example, the temperature monitoring unit 402 may be monitoring the temperature of the ambient air within a predefined distance of the electrolyzer unit 106 and may transmit the temperature value to the controller 104 on determining the temperature value to be greater than the predefined temperature threshold. The controller 104 may control the first heat exchanger unit 108 to intake the liquid air stream from the second turbine 310 of the cold box unit 306. The first heat exchanger unit 108 may or bring in indirect contact the liquid air stream with the ambient air to carry out a cooling of the ambient air of the electrolyzer unit 106, thereby cooling the electrolyzer unit 106.

In an embodiment, the controller 104 may restrict the supply of the liquid air stream into the first heat exchanger unit 108 from the cold box unit 306 based on the determination that a temperature value of the ambient air is less than the predefined temperature threshold.

In an embodiment, an amount of energy that may be required to operate the air separation unit 110 for cryogenic process of cooling down the purified compressed air in the cold box unit 306 to produce the liquid nitrogen stream and the liquid nitrogen stream may be obtained from solar PV plants. The temperature value of the ambient air around the electrolyzer unit 106 to be more than the predefined temperature threshold may occur during summer time. During such a time, the solar PV plants may get more sunlight and the extra energy produced by the solar PV plants may be used for operating the air separation unit 110 or the cold box unit 306. For example, the first turbine 308 and the second turbine 310 may be operated using extra energy produced by the solar PV plants to produce the liquid nitrogen stream and the liquid air stream, making the entire cryogenic air cooling process more energy efficient, environment-friendly and sustainable.

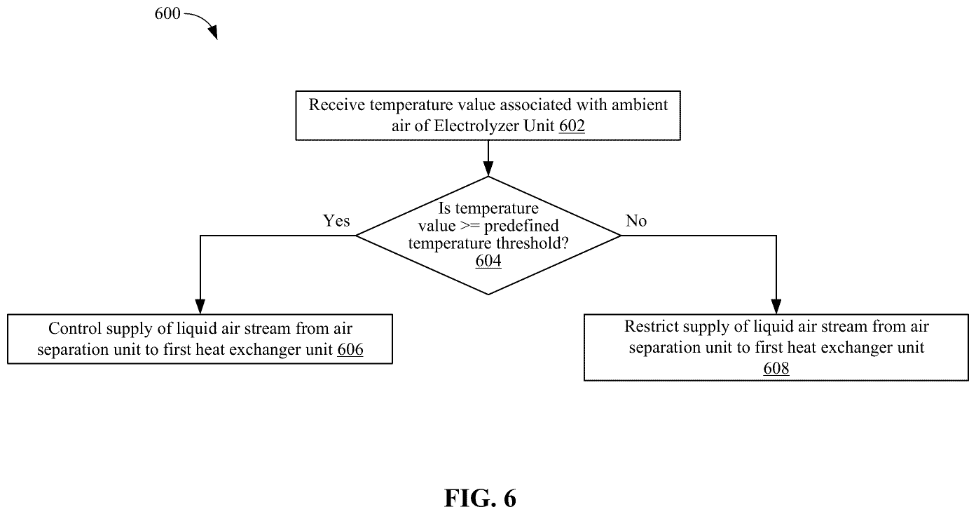

FIG. 6 is a flowchart 600 of an exemplary method for controlling a flow of the liquid air stream, in accordance with an embodiment of the disclosure. FIG. 6 is explained in conjunction with elements from FIG. 1, FIG. 2, FIG. 3, FIG. 4, and FIG. 5. The operations of the exemplary method may be executed by any computing system, for example, by the controller 104 of FIG. 1 or the processor 202 of FIG. 2. The operations of the flowchart 600 may start at 602.

At 602, a temperature value associated with ambient air of the electrolyzer unit 106 is received. In an embodiment, the controller 104 or the processor 202 is configured to receive the temperature value associated with the ambient air. The ambient air is proximal to the electrolyzer unit 106. In

At 604, a determination is made to check if the temperature value is greater than or equal to a predefined temperature threshold. In an embodiment, the controller 104 or the processor 202 is configured to compare the temperature value with the predefined temperature threshold to determine if the temperature value is greater than or equal to the predefined temperature threshold. By continuously retrieving and comparing the temperature value with the predefined threshold, the apparatus 102 monitors if the electrolyzer unit 106 is operating within its optimal operating range or not.

In an embodiment, the predefined temperature threshold is established based on empirical data and operational parameters that indicate a temperature at which the electrolyzer unit 106 performs optimally. If the temperature value exceeds the predefined temperature threshold, it can lead to increased resistance within the electrolytic cells, resulting in a decrease in the overall efficiency of hydrogen production.

Further, if the temperature value is greater than or equal to the predefined threshold, at 606, a supply of the liquid air stream from the air separation unit 110 to the first heat exchanger unit 108 is controlled. In an embodiment, the controller 104 or the processor 202 is configured to control the supply of the liquid air stream from the air separation unit 110 to the first heat exchanger unit 108 based on the determination. In this manner, the controller 104 may trigger a series of corrective actions to mitigate any potential negative impacts on the electrolyzer unit's performance due to increased temperature.

In an embodiment, the liquid air stream serves as a cooling medium that may absorb excess heat from the ambient air around the electrolyzer unit 106. The first heat exchanger unit 108 is designed to provides increased surface area to enable transfer of thermal energy from the warmer ambient air to the liquid air stream.

In certain cases, the controller 104 may also determine different ranges of temperature for the operation of the electrolyzer unit 106. These different ranges may correspond to, for example, very high or critical temperature range, high temperature range, medium temperature range, and low or desired temperature range. In an example, the controller 104 determines that the temperature value of the ambient air lies in the high temperature range. In such a case, the controller 104 may control the first heat exchanger 108 and the air separation unit 110 such that a flow rate or a speed of transfer of the liquid air stream from the air separation unit 110 to the first heat exchanger 108 is high. In another example, the controller 104 determines that the temperature value of the ambient air lies in the very high or critical temperature range. In such a case, the controller 104 may control the first heat exchanger 108 and the air separation unit 110 such that a flow rate or a speed of transfer of the liquid air stream from the air separation unit 110 to the first heat exchanger 108 is very high to ensure that fast heat exchange can be done. This increase in supply enhances the cooling capacity of the first heat exchanger unit 108, allowing to absorb more heat from the ambient air of the electrolyzer unit 106. The liquid air stream, being at a significantly lower temperature, effectively cools the ambient air, thereby reducing the overall temperature of the electrolyzer unit 106. This cooling of the electrolyzer unit 106 helps maintain the electrolyzer's performance and efficiency, ensuring that the electrolyzer unit 106 operates within its optimal temperature range.

Further, if the temperature value is lesser than the predefined threshold, at 608, a supply of the liquid air stream from the air separation unit 110 to the first heat exchanger unit 108 is restricted. In an embodiment, the controller 104 or the processor 202 is configured to restrict the supply of the liquid air stream from the air separation unit 110 to the first heat exchanger unit 108 based on the determination that the temperature value is less than the predefined temperature threshold. In addition, when the temperature value is less than the predefined temperature threshold, the controller 104 may restart monitoring of the temperature of the ambient air based on sensor data received from the temperature monitoring unit 402.

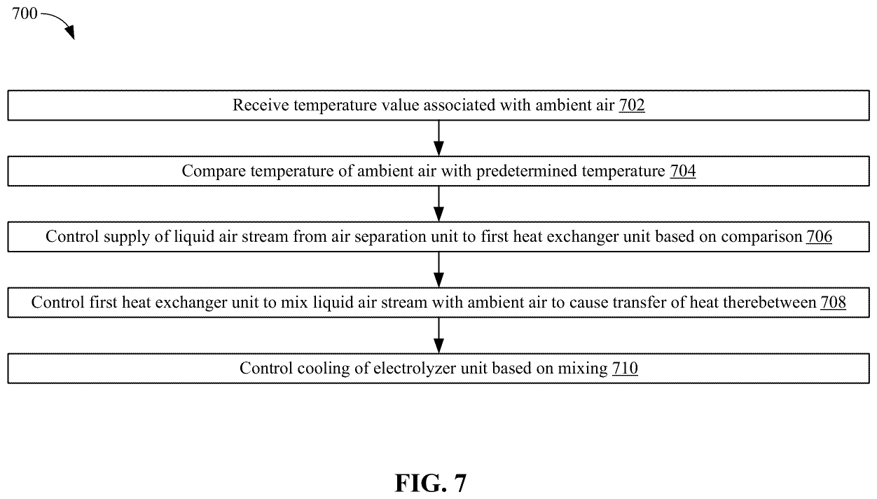

FIG. 7 is a flowchart 700 of an exemplary method for controlling the cooling of the electrolyzer unit 106, in accordance with an embodiment of the disclosure. FIG. 7 is explained in conjunction with elements from FIG. 1, FIG. 2, FIG. 3, FIG. 4, FIG. 5, and FIG. 6. The operations of the exemplary method may be executed by any computing system, for example, by the controller 104 of FIG. 1 or the processor 202 of FIG. 2. The operations of the flowchart 700 may start at 702.

At 702, a temperature value associated with ambient air is received. In an embodiment, the controller 104 or the processor 202 is configured to receive the temperature value associated with the ambient air. The ambient air is proximal to the electrolyzer unit 106.

At 704, the temperature value is compared with the predefined temperature threshold. In an embodiment, the controller 104 or the processor 202 is configured to compare the temperature value with the predefined temperature threshold.

At 706, a supply of a liquid air stream from the air separation unit 110 to the first heat exchanger unit 108 is controlled based on the comparison. In an embodiment, the controller 104 or the processor 202 is configured to control the supply of the liquid air stream from the air separation unit 110 to the first heat exchanger unit 108 based on the comparison. It may be noted, the air separation unit 110 separates one or more components of compressed air to produce the liquid air stream.

At 708, the first heat exchanger unit 108 is controlled to mix the liquid air stream with the ambient air. In an embodiment, the controller 104 or the processor 202 is configured to control the first heat exchanger unit 108 to mix the liquid air stream with the ambient air. The mixing of the liquid air stream and the ambient air causes transfer of heat therebetween.

At 710, the cooling of the electrolyzer unit 106 is controlled based on the mixing. In an embodiment, the controller 104 or the processor 202 is configured to control the colling of the electrolyzer unit 106 based on the mixing.

Accordingly, blocks of the flowcharts 600 and 700 support combinations of means for performing the specified functions and combinations of operations for performing the specified functions. It will also be understood that one or more blocks of the 600 and 700 combinations of blocks in the flowcharts 600 and 700 can be implemented by special purpose hardware-based computer system which perform the specified functions, or combinations of special purpose hardware and computer instructions.

Alternatively, the controller 104 may comprise means for performing each of the operations described above. In this regard, according to an example embodiment, examples of means for performing operations may comprise, for example, the controller 104, the processor 202 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of reactants and/or functions, it should be appreciated that different combinations of reactants and/or functions may be provided by alternative embodiments without departing from the scope of the appended claims. In this regard, for example, different combinations of reactants and/or functions than those explicitly described above are also contemplated as may be set forth in some of the appended claims. Although specific terms are employed herein, they are used in a generic and descriptive sense only and not for purposes of limitation.

What is claimed is:

1. A method, comprising:
receiving a temperature value associated with ambient air, wherein the ambient air is proximal to an electrolyzer unit;
comparing the temperature value with a predefined temperature threshold;
controlling a supply of a liquid air stream from an air separation unit to a first heat exchanger unit based on the comparison, wherein the air separation unit separates one or more components of compressed air to produce the liquid air stream;
controlling the first heat exchanger unit to mix the liquid air stream with the ambient air, wherein the mixing of the liquid air stream and the ambient air causes transfer of heat therebetween; and
controlling a cooling of the electrolyzer unit based on the mixing.

2. The method of claim 1, further comprising
determining the temperature value is one of greater than or equal to the predefined temperature threshold based on the comparison; and
controlling the supply of the liquid air stream from the air separation unit to the first heat exchanger unit based on the determination.

3. The method of claim 1, wherein the method further comprises:
determining the temperature value is lesser than the predefined temperature threshold based on the comparison; and
restricting the supply of the liquid air stream from the air separation unit to the first heat exchanger unit based on the determination.

4. The method of claim 1, wherein the first heat exchanger unit is made of brazed aluminum.

5. The method of claim 1, further comprising:
providing a cold box unit within the air separation unit, wherein the cold box unit comprises a first turbine, a second turbine, and a second heat exchanger unit;
controlling each of the first turbine and the second turbine to separate the one or more components of the compressed air; and
controlling the second heat exchanger unit to regulate a temperature of the cold box unit.

6. The method of claim 5, further comprising:
controlling the first turbine to provide refrigeration for a liquid nitrogen stream;
controlling a supply of the liquid nitrogen stream from the first turbine to a storage unit; and
controlling the storage unit to store the liquid nitrogen stream.

7. The method of claim 6, further comprising
controlling at least one of: the second heat exchanger unit, or the storage unit to supply the liquid nitrogen stream to an ammonia production unit; and
controlling the ammonia production unit to produce liquid ammonia based on the supplied liquid nitrogen stream.

8. The method of claim 7, further comprising:
controlling the electrolyzer unit to produce hydrogen, wherein the electrolyzer unit produces the hydrogen and oxygen based on an electrolysis of water;
controlling the electrolyzer unit to supply the hydrogen to the ammonia production unit; and
controlling the ammonia production unit to produce liquid ammonia based on the supplied hydrogen.

9. The method of claim 5, further comprising:
controlling the second turbine to separate the liquid air stream from the compressed air, wherein the liquid air stream excludes the liquid nitrogen stream; and
controlling the supply of the liquid air stream from the second turbine to the first heat exchanger unit.

10. The method of claim 1, wherein the method further comprises:
controlling a compressor unit to generate the compressed air, wherein the compressor unit is controlled to increase a pressure associated with atmospheric air to a predefined pressure value to generate the compressed air;
controlling a supply of the compressed air from the compressor unit to a purifier unit;
controlling the purifier unit to generate purified compressed air from the compressed air;
controlling a supply of the purified compressed air from the purifier unit to the air separation unit; and
controlling the air separation unit to separate the one or more components from the purified compressed air.

11. The method of claim 1, wherein the method further comprises:
arranging a temperature monitoring unit in association with the first heat exchanger unit;
controlling the temperature monitoring unit to monitor a temperature of the ambient air within a predefined distance of the electrolyzer unit; and
receiving the temperature value associated with ambient air based on the monitoring of the temperature of the ambient air.

12. A controller, comprising:
one or more processors configured to:
receive a temperature value associated with ambient air, wherein the ambient air is proximal to an electrolyzer unit;
compare the temperature value with a predefined temperature threshold;
control a supply of a liquid air stream from an air separation unit to a first heat exchanger unit based on the comparison, wherein the air separation unit separates one or more components of compressed air to produce the liquid air stream;
control the first heat exchanger unit to mix the liquid air stream with the ambient air, wherein the mixing of the liquid air stream and the ambient air causes transfer of heat therebetween; and
control a cooling of the electrolyzer unit based on the mixing.

13. The controller of claim 12, wherein the one or more processors are further configured to:
determine the temperature value is one of greater than or equal to the predefined temperature threshold based on the comparison; and
control the supply of the liquid air stream from the air separation unit to the first heat exchanger unit based on the determination.

14. The controller of claim 11, wherein the one or more processors are further configured to:
provide a cold box unit within the air separation unit, wherein the cold box unit comprises a first turbine, a second turbine, and a second heat exchanger unit;
control each of the first turbine and the second turbine to separate the one or more components of the compressed air; and
control the second heat exchanger unit to regulate a temperature of the cold box unit.

15. The controller of claim 14, wherein the one or more processors are further configured to:
control the first turbine to separate a liquid nitrogen stream from the compressed air;
control a supply of the liquid nitrogen stream from the first turbine to a storage unit; and
control the storage unit to store the liquid nitrogen.

16. The controller of claim 15, wherein the one or more processors are further configured to:
control at least one of: the second heat exchanger unit, or the storage unit to supply the liquid nitrogen to an ammonia production unit;
control the electrolyzer unit to produce hydrogen, wherein the electrolyzer unit produces the hydrogen and oxygen based on an electrolysis of water;
control the electrolyzer unit to supply the hydrogen to the ammonia production unit; and
control the ammonia production unit to produce liquid ammonia based on the supplied liquid nitrogen stream and the supplied hydrogen.

17. The controller of claim 12, wherein the one or more processors are further configured to:
control a compressor unit to generate the compressed air, wherein the compressor unit is controlled to increase a pressure associated with atmospheric air to a predefined pressure value to generate the compressed air;
control a supply of the compressed air from the compressor unit to a purifier unit;
control the purifier unit to generate purified compressed air from the compressed air;
control a supply of the purified compressed air from the purifier unit to the air separation unit; and
control the air separation unit to separate the one or more components from the purified compressed air.

18. An apparatus, comprising:
an air separation unit configured to separate one or more components of compressed air to produce liquid air stream;
an electrolyzer unit configured to produce hydrogen and oxygen based on an electrolysis of water;
a first heat exchanger unit; and
a controller configured to:
receive a temperature value associated with ambient air, wherein the ambient air is proximal to the electrolyzer unit;
compare the temperature value with a predefined temperature threshold;
control a supply of a liquid air stream from an air separation unit to a first heat exchanger unit based on the comparison;
control the first heat exchanger unit to mix the liquid air stream with the ambient air, wherein the mixing of the liquid air stream and the ambient air causes transfer of heat therebetween; and
control a cooling of the electrolyzer unit based on the mixing.

19. The apparatus of claim 18, further comprising:
a cold box unit provided within the air separation unit, wherein the cold box unit comprises a first turbine, a second turbine, and a second heat exchanger unit; and
an ammonia production unit to produce liquid ammonia.

20. The apparatus of claim 19, wherein the controller is further configured to:
control the first turbine to separate a liquid nitrogen stream from the compressed air;
control a supply of the liquid nitrogen stream from the first turbine to a storage unit;
control the storage unit to store the liquid nitrogen stream;
control at least one of: the second heat exchanger unit, or the storage unit to supply the liquid nitrogen to the ammonia production unit;
control the electrolyzer unit to produce hydrogen, wherein the electrolyzer unit produces the hydrogen and oxygen based on an electrolysis of water;
control the electrolyzer unit to supply the hydrogen to the ammonia production unit; and
control the ammonia production unit to produce liquid ammonia based on the supplied liquid nitrogen stream and the supplied hydrogen.
